(19) United States
(12) Patent Application Publication
(10) Pub. No.: US 2009/0104315 A1
(43) Pub. Date: Apr. 23, 2009

(54) METHODS FOR ENHANCING THE PALATABILITY OF COMPOSITIONS FOR CONSUMPTION BY ANIMALS

(76) Inventors: Kim Gene Friesen, Carthage, IN (US); Ryan Michael Yamka, Topeka, KS (US); Lauren Jay Kats, Topeka, KS (US); Timothy Glen Vande Giessen, Topeka, KS (US)

Correspondence Address: COLGATE-PALMOLIVE COMPANY, 909 RIVER ROAD, PISCATAWAY, NJ, 08855, US

(21) Appl. No.: 11/813,268

(22) PCT Filed: Dec. 30, 2005
(86) PCT No.: PCT/US2005/047459

§ 371 Date: Jun. 3, 2008

Related U.S. Application Data
(60) Provisional application No. 60/640,564, filed on Dec. 30, 2004.

(51) Int. Cl. A23K 1/16; A23K 1/18; G06Q 30/00

(52) U.S. Cl. 426/87; 426/535; 705/27

(57) ABSTRACT

Methods for enhancing the palatability of compositions for consumption by an animal by adding a palatability enhancing amount of at least one methionine compound and optional inactive yeast to the compositions. The methionine compound, and optional yeast, is added to the compositions in an amount of at least about 0.01% by weight of the composition on a dry matter basis, generally in amounts of from about 0.01% to about 1.5% by weight of the composition. The compositions containing methionine compound, and optional yeast, are ingested more frequently and at a higher rate by animals, particularly finicky animals or older animals that tend not eat enough food to maintain their health.

### CROSS-REFERENCE TO RELATED APPLICATIONS

This application claims priority to U.S. Provisional Application Ser. No. 60/640,564, filed Dec. 30, 2004, the disclosure of which is incorporated herein by reference.

### BACKGROUND OF THE INVENTION

1. Field of the Invention

The invention relates generally to methods for enhancing the palatability of compositions for consumption by animals and particularly to methods for using methionine compounds to enhance palatability.

2. Description of the Related Art

Numerous potential palatability enhancers are available for pets, the only limitation appearing to be the imagination of the selector. Some are commercially available as flavoring agents. Others, inter alia, can be prepared by family recipes handed down over generations, and others are continually being synthesized anew, extracted from natural products, or digested from various animal organs. The success of these materials in compositions for animal consumption is not predictable to any great extent. Firstly, a potential palatability enhancer should be compatible with the composition during processing and packaging and it should possess a practical extended shelf-life. Secondly, the palatability enhancer should be appealing to the animals' sense of taste, smell, physical attractiveness and other attributes which appear in the overall composition. Thirdly, the palatability enhancer should be compatible with the animal after ingestion such that it does not cause any significant problems to the animal, particularly gastrointestinal problems. While many palatability enhancers are known, there is a need for new methods and compositions for increasing the palatability of compositions for animal consumption.

### SUMMARY OF THE INVENTION

It is, therefore, an object of the present invention to provide methods for enhancing the palatability of compositions for consumption by an animal.

It is another object of the invention to provide methods for increasing the amount of a composition ingested by an animal.

It is another object of the invention to provide compositions having enhanced palatability for consumption by an animal.

It is a further object of the invention to provide articles of manufacture in the form of kits that contain combinations of palatability enhancers, foods, compounds, devices, and other components useful for enhancing the palatability of compositions for consumption by an animal.

These and other objects are achieved using novel methods for enhancing the palatability of compositions for consumption by an animal. The methods comprise adding a palatability enhancing amount of at least one methionine compound and optional inactive yeast to the compositions. The methionine compound, and optional yeast, is added to the compositions in an amount of at least about 0.01% by weight of the composition on a dry matter basis, generally in amounts of from about 0.01% to about 1.5% by weight of the composition.

Other and further objects, features, and advantages of the invention will be readily apparent to those skilled in the art.

### DETAILED DESCRIPTION OF THE INVENTION

The invention provides methods for enhancing the palatability of compositions for animal consumption. The methods comprise adding a palatability enhancing amount of at least one methionine compound to the composition. Adding a methionine compound to compositions for animal consumption imparts enhanced palatability to the compositions when measured against compositions for animal consumption that do not contain a methionine compound.

In one embodiment, the invention further comprises adding a palatability enhancing amount of inactive yeast to the composition.

The invention also provides compositions for consumption by an animal comprising a palatability enhancing amount of at least one methionine compound and optional inactive yeast.

The invention further provides methods for increasing the amount of a food or other composition ingested by an animal comprising feeding the animal a composition comprising a palatability enhancing amount of at least one methionine compound and optional inactive yeast. When the compositions have increased palatability, the animal ingests more of the compositions.

The methionine compound is added to the compositions in an amount of at least about 0.01% by weight of the composition on a dry matter basis. Generally, the methionine compound is added to the compositions in amounts of from about 0.01% to about 1.5%. In certain embodiments, the amount of methionine compound added to the compositions is from about 0.02% to about 1% by weight. In other embodiments, the amount of methionine added to the compositions is from about 0.05% to about 0.5% by weight. In other, the amount of methionine added to the compositions is from about 0.1% to about 1.5% by weight.

Any type or form of a methionine compound that is compatible with compositions for animal consumption may be used in the invention. For example, the methionine compound may be an analog or derivative of methionine. Examples of suitable analogs or derivatives of methionine include D-methionine, L-methionine, mixtures of D-methionine and L-methionine, normethionine, homomethionine, methioninol, hydroxy methionine, ethionine, S-adenosyl-methionine, methionine sulfone, methionine sulfoxide and pharmaceutically acceptable salts thereof. The methionine compounds for use in the invention can be in the D-, L-, or DL-form, and include pharmaceutically acceptable N-(mono- and dicarboxylic acid) acyl derivatives and alkyl esters thereof. Exemplary acyl derivatives include the formyl, acetyl, propionyl, and succinyl derivatives. Exemplary ester derivatives include the methyl, ethyl, propyl, isopropyl, and butyl esters.

The inactive yeast is added to the compositions in an amount of at least about 0.01% by weight of the composition on a dry matter basis. Generally, the yeast is added to the compositions in amounts of from about 0.01% to about 1.5%. In certain embodiments, the amount of yeast compound added to the compositions is from about 0.02% to about 1% by weight. In other embodiments, the amount of yeast added to the compositions is from about 0.05% to about 0.5% by weight. In other, the amount of yeast added to the compositions is from about 0.1% to about 1.5% by weight.

Any type or form of inactive yeast that is compatible with compositions for animal consumption may be used in the invention. Examples of suitable inactive yeasts include, without limitation, brewer's yeast, nutritional yeast and torula yeast.

The methionine compound, inactive yeast, and other ingredients should be present at concentrations that are not deleterious to the intended animal's health. Thus, for example, the methionine compound, inactive yeast and other ingredients should be present at concentrations that do not cause undesirable effects on digestion, particularly long term undesirable effects on digestion, such as undesirable effects lasting several days or longer. Undesirable effects on digestion may include, for example, constipation or diarrhea.

The methods and compositions of the invention are useful for a variety of human and non-human animals, including avian, bovine, canine, equine, feline, hicrine, murine, ovine, and porcine animals, and are particularly useful for companion animals such as canines and felines, including dogs and cats.

The methods of the invention will be found especially beneficial if an animal is, or has become, finicky, has poor appetite, or is in ill health, all of which can occur in animals of all ages but especially in aged animals. The method is especially beneficial if the food composition is one to which the animal is unaccustomed or if the food composition contains ingredients or a balance of ingredients designed to improve health or wellness with less emphasis on palatability.

The invention provides a variety of compositions for animal consumption containing a methionine compound and optional inactive yeast. Compositions include, for example, foods, supplements, treats, and toys (typically chewable and consumable toys).

In some embodiments, the composition is a food. Both liquid and solid foods are provided. Where the food is solid, the methionine compound and/or inactive yeast may be coated on the food, incorporated into the food, or both. Solid foods include both dry foods and wet foods. In one embodiment, the methionine compound and optional yeast are topically applied to the composition.

The non-methionine and non-yeast components of the food and their typical proportions are known to skilled artisans. In one embodiment, the composition is a food comprising:
(a) at least about 0.01% of a methionine compound topically applied to the food composition; and
(b) at least one of the following:
   (i) from about 2% to about 70% (or from about 10% to about 70%, or from about 10% to about 60%) protein, and
   (ii) from about 2% to about 50% (or from about 2% to about 50%, or from about 2% to about 40%) fat.

In such an embodiment, the composition also may, for example, comprise at least one of the following:
(a) no greater than about 50% (or from about 2% to about 42%) carbohydrate,
(b) no greater than about 40% (or from about 1% to about 20%, or from about 1% to about 5.2%) dietary fiber, and
(c) no greater than about 12% (or no greater than about 10%, or from about 2% to about 8%) of one or more nutritional balancing agents.

In another embodiment, the composition is a food that comprises the following:
(a) at least about 0.02% to about 1.5% of a methionine compound topically applied to the food composition,
(b) from about 2% to about 70% (or from about 10% to about 70%, or from about 10% to about 60%) protein,
(c) from about 2% to about 50% (or from about 2% to about 50%, or from about 2% to about 40%) fat,
(d) no greater than about 50% (or from about 2% to about 42%) carbohydrate,
(e) no greater than about 40% (or from about 1% to about 20%, or from about 1% to about 5.2%) dietary fiber, and
(f) no greater than about 12% (or no greater than about 10%, or from about 2% to about 8%) of one or more nutritional balancing agents.

In an embodiment, the composition is a food that comprises the following:
(a) at least about 0.01% of an inactive yeast topically applied to the food composition; and
(b) at least one of the following:
   (i) from about 2% to about 70% (or from about 10% to about 70%, or from about 10% to about 60%) protein, and
   (ii) from about 2% to about 50% (or from about 2% to about 50%, or from about 2% to about 40%) fat.

In such an embodiment, the composition also may, for example, comprise at least one of the following:
(a) no greater than about 50% (or from about 2% to about 42%) carbohydrate,
(b) no greater than about 40% (or from about 1% to about 20%, or from about 1% to about 5.2%) dietary fiber, and
(c) no greater than about 12% (or no greater than about 10%, or from about 2% to about 8%) of one or more nutritional balancing agents.

In another embodiment, the composition is a food that comprises the following:
(a) at least about 0.02% to about 2% of inactive yeast topically applied to the food composition,
(b) from about 2% to about 70% (or from about 10% to about 70%, or from about 10% to about 60%) protein,
(c) from about 2% to about 50% (or from about 2% to about 50%, or from about 2% to about 40%) fat,
(d) no greater than about 50% (or from about 2% to about 42%) carbohydrate,
(e) no greater than about 40% (or from about 1% to about 20%, or from about 1% to about 5.2%) dietary fiber, and
(f) no greater than about 12% (or no greater than about 10%, or from about 2% to about 8%) of one or more nutritional balancing agents.

In still another embodiment, the composition is a food that comprises the following:
(a) at least about 0.01% of a methionine compound topically applied to the food composition;
(b) at least about 0.01% of inactive yeast topically applied to the food composition; and
(c) at least one of the following:
   (i) from about 2% to about 70% (or from about 10% to about 70%, or from about 10% to about 60%) protein, and
   (ii) from about 2% to about 50% (or from about 2% to about 50%, or from about 2% to about 40%) fat.

Specific suitable amounts for each component in a composition will depend on a variety of factors including, for example, the species of animal consuming the composition; the particular components included in the composition; the age, weight, general health, sex, and diet of the animal; the animal's consumption rate; and the like. Thus, the component amounts may vary widely, and may even deviate from the proportions set forth in this patent.

The protein in the compositions of the invention may be supplied by a variety of sources, including, plant sources, animals sources, or both. Animal sources include, for example, meat, meat by-products, dairy, eggs, etc. Meats include, for example, the flesh of poultry; fish; and mammals (e.g., cattle, swine, sheep, goats, and the like). Meat by-products include, for example, lungs, kidneys, brain, livers, and stomachs and intestines (preferably freed of essentially all or all their contents).

The fat and carbohydrate in the compositions of the invention may be supplied by a variety of sources, including, for example, meat, meat by-products, other animal or plant protein sources, grains, and mixtures thereof. Grains include, for example, wheat, corn, barley, and rice.

Fiber in the compositions of the invention may be supplied from a variety of sources, including, for example, vegetable fiber sources such as cellulose, beet pulp, peanut hulls, and soy fiber.

Particularly in instances when the composition is an animal food, vitamins and minerals preferably are included in amounts required to avoid deficiency and maintain health. These amounts are readily available in the art. The National Research Council (NRC), for example, provides recommended amounts of such ingredients for farm animals. See, e.g., Nutrient Requirements of Swine (10th Rev. Ed., Nat'l Academy Press, Wash. D.C., 1998), Nutrient Requirements of Poultry (9th Rev. Ed., Nat'l Academy Press, Wash. D.C., 1994), Nutrient Requirements of Horses (5th Rev. Ed., Nat'l Academy Press, Wash. D.C., 1989), etc. The American Feed Control Officials (AAFCO), for example, provides recommended amounts of such ingredients for dogs and cats. See American Feed Control Officials, Incorp., Official publication, pp. 126-140 (2003). Vitamins generally useful as food additives include, for example, vitamin A, vitamin B1, vitamin B2, vitamin B6, vitamin B12, vitamin C, vitamin D, vitamin E, vitamin H (biotin), vitamin K, folic acid, inositol, niacin, and pantothenic acid. Minerals and trace elements generally useful as food additives include, for example, calcium, phosphorus, sodium, potassium, magnesium, copper, zinc, choline, and iron salts.

The compositions of the invention may further contain additives known in the art. Such additives should be present in amounts that do not impair the purpose and effect provided by the invention. Examples of additives include, for example, substances with a stabilizing effect, organoleptic substances, processing aids and substances that provide nutritional benefits.

Stabilizing substances include, for example, substances that tend to increase the shelf life of the composition. Potentially suitable examples of such substances include, for example, preservatives, antioxidants, synergists and sequestrants, packaging gases, stabilizers, emulsifiers, thickeners, gelling agents, and humectants. Examples of emulsifiers and/or thickening agents include, for example, gelatin, cellulose ethers, starch, starch esters, starch ethers, and modified starches.

Additives for coloring, palatability, and nutritional purposes include, for example, colorants; sodium chloride, iron oxide, potassium citrate, potassium chloride, and other edible salts; vitamins; minerals; and flavoring. The amount of such additives in a composition typically is up to about 5% by weight (dry basis of the composition).

Supplements include, for example, a feed used with another feed to improve the nutritive balance or performance of the total. Supplements include compositions that are fed undiluted as a supplement to other feeds, offered free choice with other parts of an animal's ration that are separately available, or diluted and mixed with an animal's regular feed to produce a complete feed. The AAFCO, for example, provides a discussion relating to supplements in the American Feed Control Officials, Incorp. Official Publication, p. 220 (2003). Supplements may be in various forms including, for example, powders, liquids, syrups, pills, encapsulated compositions, etc.

Treats include, for example, compositions that are given to an animal to entice the animal to eat during a non-meal time. Treats for canines include, for example, dog bones. Treats may be nutritional, wherein the composition comprises one or more nutrients, and may, for example, have a composition as described above for food. Non-nutritional treats encompass any other treats that are non-toxic. The methionine compound can be coated onto the treat, incorporated into the treat, or both.

Toys include, for example, chewable toys. Toys for dogs include, for example, artificial bones. The iron oxide can form a coating on the surface of the toy or on the surface of a component of the toy, be incorporated partially or fully throughout the toy, or both. In an embodiment, the iron oxide is orally accessible by the intended user. There a wide range of suitable toys currently marketed. See, e.g., U.S. Pat. No. 5,339,771 and references disclosed therein). See also, e.g., U.S. Pat. No. 5,419,283 and references disclosed therein. The invention provides both partially consumable toys (e.g., toys comprising plastic components) and fully consumable toys (e.g., rawhides and various artificial bones). The invention also provides toys for both human and non-human use, particularly for companion, farm, and zoo animal use, and particularly for dog, cat, or bird use.

In preparing a composition of the invention, the methionine compound and the optional inactive yeast may be incorporated into the composition during the processing of the formulation, such as during and/or after mixing of other components of the composition. Distribution of these components into the composition can be accomplished by conventional means. In one embodiment, the methionine compound and the optional inactive yeast are topically applied to the food and other compositions to produce the compositions of the present invention.

Compositions of the invention (particularly foods) can be prepared in a dry form using conventional processes. In one embodiment, dry ingredients, including, for example, animal protein sources, plant protein sources, grains, etc. are ground and mixed together. Moist or liquid ingredients, including fats, oils, animal protein sources, water, etc. are then added to and mixed with the dry mix. The mixture is then processed into kibbles or similar dry pieces. Kibble is often formed using an extrusion process in which the mixture of dry and wet ingredients is subjected to mechanical work at a high pressure and temperature, and forced through small openings and cut off into kibble by a rotating knife. The wet kibble is then dried and optionally coated with one or more topical coatings which may include, for example, flavors, fats, oils, powders, and the like. Kibble also can be made from the dough using a baking process, rather than extrusion, wherein the dough is placed into a mold before dry-heat processing.

The palatability enhancing agents, (i.e., the methionine compound and/or inactive yeast) may be added to the food composition in its normal preparation procedure such as mixing, extrusion, baking and the like or is preferably added after its preparation, for example, post extrusion, such as by spraying or coating the surface of the food. This is particularly desirable for dry foods wherein the extruded strands can be contacted with the palatability enhancing agents (or a solution comprising the palatability agents) by spraying or coating the extruded strands before the strands are cut into a kibble, or the kibble can be contacted with the palatability enhancing agents (or a solution comprising the palatability enhancing agents) by spraying, coating or dipping the kibble per se.

For topical application to a food, the palatability enhancing agents may be mixed with a carrier composition to facilitate application to the surface of the food composition. For example, a liquid, slurry, light gel, or watery solid can all be utilized as a carrier for the methionine compound and/or inactive yeast of this composition. Standard spraying or dipping apparatus can be employed to apply the palatability enhancing agents to the surface of the food composition. An example of such a carrier is a minced animal by-product treated with proteases in conjunction with amino acids, reducing sugar(s) and thiamin. The carrier is then mixed with the palatability enhancing agents and coated onto a kibble, thereby preparing a very palatable and acceptable dry food. In a certain preferred embodiment, the methionine compound and/or inactive yeast may simply be mixed with a commercial liquid palatant enhancer or other flavor composition to create a novel flavor palatant which can then be topically applied to the composition. Suitable commercial liquid palatant enhancers for use with the palatability enhancing agents in the invention include any known or commercially available liquid palatant enhancers commercially available from pet food palatant enhancer or other flavor suppliers known to those of skill in the art.

It is important to note that when the palatability enhancing agents of the invention (i.e., the methionine compound and/or inactive yeast) are topically applied to the composition, the palatability enhancing agents may be present in one or more surface zones on the exterior of the discrete particles of the composition (i.e., kibble). Such surface zones may be typically created by topical application (i.e., spraying, dipping, coating, and the like) as described above but are not limited by the process which is used to create the zones. Further, it is important to note that the one or more surface zones comprising the methionine compound and/or inactive yeast may substantially cover a majority or all of the discrete particles.

Compositions of the invention (particularly foods) can be prepared in a canned or wet form using conventional pet food processes. In one embodiment, ground animal (e.g., mammal, poultry, and/or fish) proteinaceous tissues are mixed with the other ingredients, including fish oils, cereal grains, other nutritionally balancing ingredients, special purpose additives (e.g., vitamin and mineral mixtures, inorganic salts, cellulose and beet pulp, bulking agents, and the like). Water sufficient for processing may also be added. The wet form ingredients are typically mixed in a vessel suitable for heating while blending the components. Heating of the mixture may be effected using any suitable manner, such as, for example, by direct steam injection or by using a vessel fitted with a heat exchanger. Following the addition of the last ingredient, the mixture is heated to a temperature range of from about 50° F. to about 212° F. Temperatures outside this range are acceptable, but may be commercially impractical without use of other processing aids. When heated to the appropriate temperature, the material will typically be in the form of a thick liquid. The thick liquid is filled into cans. A lid is applied, and the container is hermetically sealed. The sealed can is then placed into conventional equipment designed to sterilize the contents. This is usually accomplished by heating to temperatures of greater than about 230° F. for an appropriate time, which is dependent on, for example, the temperature used and the composition.

For wet foods, the methionine compound and/or inactive yeast can be incorporated into the wet food composition along with a carrier such as an alcohol composition (i.e., propylene glycol or dipropylene glycol), a cyclodextrin, a maltodextrin or a starch. Alternatively, the methionine compound and/or inactive yeast can be mixed into the dry materials prior to forming the wet food composition.

Treats of the invention can be prepared by, for example, an extrusion or baking process similar to those described above for dry food. Other processes also may be used to either coat the methionine compound and/or inactive yeast on the exterior of existing treat forms, or inject it into an existing treat form.

Animal toys of the invention are typically prepared by coating any existing toy with the flavoring composition, for example, the methionine compound and/or inactive yeast mixed with a carrier composition.

The invention provides dry compositions for consumption by an animal. In one embodiment, the composition comprises at least one methionine compound that has been topically applied to the composition in an amount of at least about 0.01% by weight of the composition. In another, the composition comprises inactive yeast that has been topically applied to the composition in an amount of at least about 0.01% by weight of the composition. In a further embodiment, the composition comprises a plurality of discrete pieces each having one or more surface zones comprising at least one methionine compound in an amount effective to enhance palatability of the composition. In another, the surface zone(s) comprise a methionine compound in an amount of from about 0.05% to about 0.5% by weight of the composition and inactive yeast in an amount of from about 0.05% to about 0.5% by weight of the composition.

The term “single package” means that the components of a kit are physically associated in or with one or more containers and considered a unit for manufacture, distribution, sale, or use. Containers include, but are not limited to, bags, boxes, bottles, shrink wrap packages, stapled or otherwise affixed components, or combinations thereof. A single package may be containers of individual food compositions physically associated such that they are considered a unit for manufacture, distribution, sale, or use.

The term “virtual package” means that the components of a kit are associated by directions on one or more physical or virtual kit components instructing the user how to obtain the other components, e.g., in a bag containing one component and directions instructing the user to go to a website, contact a recorded message, view a visual message, or contact a caregiver or instructor to obtain instructions on how to use the kit.

In a further aspect, the invention provides kits suitable for administering a composition for animal consumption having enhanced palatability to an animal. The kits comprise in separate containers in a single package or in separate containers in a virtual package, as appropriate for the kit component, a palatability enhancing amount of at least one methionine compound and at least one of (1) an inactive yeast, (2) one or more ingredients suitable for consumption by an animal, (3) instructions for how to combine the methionine compound and optional yeast and the ingredient(s) to produce a composition for animal consumption having enhanced palatability, and (4) instructions for how to use the composition of the invention, particularly for the benefit of the animal, more particularly for increasing the amount of a composition ingested by an animal. When the kit comprises a virtual package, the kit is limited to instructions in a virtual environment in combination with one or more physical kit components. The kit contains the methionine compound and optional yeast in amounts sufficient to enhance the palatability of the ingredient. Generally, kits contain the methionine compound and/or yeast in amounts sufficient to produce a composition having at least about 0.01% methionine compound and/or yeast, most preferably in amounts of from about 0.01% to about 1.5%, and at least one ingredient selected from the group consisting of protein, fat, carbohydrate, fiber, and combinations thereof. Typically, the methionine compound and/or yeast and the ingredient(s) are admixed just prior to consumption by an animal. In one embodiment, the kit contains a packet of methionine compound and a container of food for consumption by an animal. The kit may contain additional items such as a device for mixing the methionine compound and ingredient or a device for containing the admixture, e.g., a food bowl. In another embodiment, the methionine compound is mixed with additional nutritional supplements such as vitamins and minerals that promote good health in an animal.

In another aspect, the invention provides a means for communicating information about or instructions for one or more of (1) using methionine compounds and optional inactive yeasts to enhance the palatability of compositions for animal consumption, (2) using methionine compounds and optional inactive yeasts to increase the amount of a composition ingested by an animal, (3) admixing methionine compounds and optional inactive yeasts with the other components of the present invention, and (4) using the kits of the present invention for enhancing the palatability of compositions for consumption by an animal, and (6) using the kits of the present invention to increase the amount of a composition ingested by an animal. The communicating means comprises a document, digital storage media, optical storage media, audio presentation, or visual display containing the information or instructions. Preferably, the communication is a displayed web site or a brochure, product label, package insert, advertisement, or visual display containing such information or instructions. Useful information includes one or more of (1) methods and techniques for combining and administering the methionine compound and optional yeast and ingredient(s) and (2) contact information for patients to use if they have a question about the invention and its use. Useful instructions include amounts for mixing and administration amounts and frequency. The communication means is useful for instructing on the benefits of using the invention and communicating the approved methods for administering the invention to an animal.

All percentages expressed herein are on a weight by dry matter basis unless specifically stated otherwise. This invention is not limited to the particular methodology, protocols, and reagents described herein because they may vary. Further, the terminology used herein is for the purpose of describing particular embodiments only and is not intended to limit the scope of the invention. As used herein and in the appended claims, the singular forms “a,” “an,” and “the” include plural reference unless the context clearly dictates otherwise, e.g., reference to “a yeast” includes a plurality of such yeasts. Similarly, the words “comprise”, “comprises”, and “comprising” are to be interpreted inclusively rather than exclusively.

Unless defined otherwise, all technical and scientific terms and any acronyms used herein have the same meanings as commonly understood by one of ordinary skill in the art in the field of the invention. Although any methods and materials similar or equivalent to those described herein can be used in the practice of the invention, the preferred methods, devices, and materials are described herein.

All patents, patent applications, and publications mentioned herein are incorporated herein by reference to the extent allowed by law for the purpose of describing and disclosing the compounds, processes, techniques, procedures, technology, articles, and other compositions and methods disclosed therein that might be used with the invention. However, nothing herein is to be construed as an admission that the invention is not entitled to antedate such disclosure by virtue of prior invention.

### EXAMPLES

The invention can be further illustrated by the following examples of preferred embodiments thereof, although it will be understood that these examples are included merely for purposes of illustration and are not intended to limit the scope of the invention unless otherwise specifically indicated.

### Example 1

This example demonstrates the effect of a methionine compound as a palatability enhancer when added to a dry, commercial feline food composition. The experiment comprised adding methionine (0.25% by weight) as an ingredient to a dry, commercial feline food to form a test composition. The dry, commercial feline food comprised poultry meal, whole yellow corn, milled brewer's rice, corn gluten meal, pork fat, chicken liver flavor, potassium chloride, calcium sulfate, choline chloride, iodized salt, vitamin E, vitamin premix, taurine, preservative and mineral premix.

The test composition was compared against a control composition in a palatability test. The control composition comprised a dry, commercial feline food without addition of a methionine compound. The control composition comprised poultry meal, whole yellow corn, milled brewer's rice, corn gluten meal, pork fat, chicken liver flavor, potassium chloride, calcium sulfate, choline chloride, iodized salt, vitamin E, vitamin premix, taurine and mineral premix. Palatability was determined by comparing the test composition and the control composition in a standard two-bowl preference test over two days with 25 cats. The tests were conducted by providing the animals with access to equal amounts (approximately 120 g) of the test composition and the control composition at the same time. At the end of 20 hours, the compositions were collected and weighed to determine how much of each composition was consumed.

Preference for the test composition was compared to the control composition and assigned a rating of “win”, “parity” or “loss” as determined by statistical analysis. A “win” indicates that the test composition was more preferred than the control composition. “Parity” means that the difference in preference for the test composition and the control composition was not found to be statistically significant. A “loss” indicates that the animals preferred the control composition over the test composition. It is important to note that a portion of the animals in the test may not have demonstrated a true preference such that a sum of all results would not necessarily equal 100%.

Results are shown below in Table 1. No evidence of any intolerance of the compositions was observed in the cats following intake.

TABLE 1

| Exp. | | Status (vs. | Intake | % Pref. | % Pref. |
|---|---|---|---|---|---|
| No. | Test composition | control) | Ratio | Test | Control |
| 1 | Dry, commercial | Loss | 0.3782 | 31.6 | 68.4 |
| | feline food with | | | | |
| | 0.25% a methionine | | | | |
| | compound in base | | | | |
| | product | | | | |

### Example 2

This example demonstrates the effect of a methionine compound coating as a palatability enhancer when topically applied to a dry, commercial feline food composition. The experiment comprised adding methionine (0.2% by weight, dry basis) as an ingredient to a dry, commercial feline food and then topically applying methionine (0.1% by weight, dry basis) to form a test composition. The dry, commercial feline food comprised poultry meal, milled brewer's rice, corn gluten meal, pork fat, whole yellow corn, cellulose, chicken liver flavor, potassium chloride, soybean oil, choline chloride, calcium carbonate, vitamin E, taurine, iodized salt, vitamin premix, calcium sulfate and mineral premix.

The test composition was compared against a control composition in a palatability test. The control composition comprised a dry, commercial feline food with methionine (0.2% by weight, dry basis) in the base product. The control composition comprised poultry meal, milled brewer's rice, corn gluten meal, whole yellow corn, cellulose, pork fat, chicken liver flavor, calcium sulfate dehydrate, soybean oil, potassium chloride, 60% choline chloride, DL-methionine, iodized salt, taurine, vitamin premix, calcium carbonate and mineral premix. Palatability was determined by comparing the test composition and the control composition in a standard two-bowl preference test over two days with 25 cats as described in Example 1. Results are shown below in Table 2. No evidence of any intolerance of the compositions was observed in the cats following intake.

TABLE 2

| | Status (vs. | Intake | % Pref. | % Pref. |
|---|---|---|---|---|
| Test composition | control) | Ratio | Test | Control |
| Dry, commercial feline food | Win | 0.7190 | 88.2 | 11.8 |
| with 0.1% methionine in | | | | |
| coating and 0.2% methionine | | | | |
| in base product | | | | |

### Example 3

This example demonstrates the effect of a methionine compound as a palatability enhancer when topically applied to a dry, commercial feline food composition. The experiment comprised topically applying methionine (0.25% by weight, dry basis) to a dry, commercial feline food to form a test composition. The dry, commercial feline food comprised rice, poultry meal, corn gluten meal, whole yellow corn, shortening vegetable, chicken, wheat gluten, corn syrup, pork fat, chicken liver flavor, egg, potassium chloride, choline chloride, flaxseed, processing aid, iodized salt, calcium carbonate, calcium sulfate, vitamin E, taurine, vitamin premix, mineral premix and preservative.

The test composition was compared against a control composition in a palatability test. The control composition comprised a dry, commercial feline food with methionine (0.21% by weight, dry basis) in the base product. The control composition comprised rice, poultry meal, corn gluten meal, whole yellow corn, shortening vegetable, ground chicken, wheat gluten, corn syrup, pork fat, chicken liver flavor, egg, potassium chloride, choline chloride, flaxseed, processing aid, iodized salt, DL-methionine, calcium carbonate, calcium sulfate, dicalcium phosphate, vitamin E, vitamin premix, taurine, mineral premix and preservative. Palatability was determined by comparing the test composition and the control composition in a standard two-bowl preference test over one day with 25 cats as described in Example 1 above. Results are shown below in Table 3. No evidence of any intolerance of the compositions was observed in the cats following intake.

TABLE 3

| | Status (vs. | Intake | % Pref. | % Pref. |
|---|---|---|---|---|
| Test Composition | control) | Ratio | Test | Control |
| Dry, commercial feline | Win | 0.7552 | 88.9 | 5.6 |
| food with 0.25% | | | | |
| methionine in coating | | | | |

### Example 4

This example demonstrates the effect of a methionine compound and inactive yeast as palatability enhancers when topically applied to a dry, commercial feline food composition. The experiment comprised topically applying methionine (0.2% by weight, dry basis) and brewer's yeast (0.2% by weight, dry basis) to a dry, commercial feline food to form a test composition. The dry, commercial feline food comprised whole yellow corn, poultry meal, corn gluten meal, chicken fat, soybean mill run, chicken liver flavor, cellulose, potassium chloride, choline chloride, calcium carbonate, iodized salt, calcium sulfate, vitamin E, vitamin premix, potassium citrate, taurine, fish oil, mineral premix and L-arginine.

The test composition was compared against a control composition in a palatability test. The control composition comprised a dry, commercial feline food with methionine (0.2% by weight, dry basis) and brewer's yeast (0.2% by weight, dry basis) in the base product. The control composition comprised poultry meal, milled brewer's rice, corn gluten meal, whole yellow corn, pork fat, soybean mill run, chicken liver flavor, cellulose, potassium chloride, choline chloride, calcium carbonate, iodized salt, calcium sulfate, yeast, DL-methionine, vitamin E, vitamin premix, potassium citrate, taurine, fish oil, mineral premix and L-arginine. Palatability was determined by comparing the test composition and the control composition in a standard two-bowl preference test over one day with 25 cats as described in Example 1. Results are shown below in Table 4. No evidence of any intolerance of the compositions was observed in the cats following intake.

TABLE 4

| | Status (vs. | Intake | % Pref. | % Pref. |
|---|---|---|---|---|
| Test Composition | control) | Ratio | Test | Control |
| Dry, commercial feline food | Parity | 0.5211 | 56.5 | 43.5 |
| with 0.2% brewer's yeast | | | | |
| and 0.2% methionine in | | | | |
| coating | | | | |

### Example 5

This example demonstrates the effect of a methionine compound as a palatability enhancer when topically applied to a dry, commercial feline food composition. The experiment comprised topically applying methionine (0.2% by weight, dry basis) and brewer's yeast (0.2% by weight, dry basis) to a dry, commercial feline food to form two test compositions. The compositions were identical except that the second test composition included a commercial dry palatability enhancer in place of the chicken liver flavor. The dry, commercial feline food comprised whole yellow corn, poultry meal, corn gluten meal, chicken fat, soybean mill run, palatability enhancer (chicken liver flavor in test composition 1 and commercial dry palatability enhancer in test composition 2), cellulose, potassium chloride, choline chloride, calcium carbonate, iodized salt, calcium sulfate, vitamin E, vitamin premix, potassium citrate, taurine, fish oil, mineral premix and L-arginine.

Each test composition was then compared against a control composition in a palatability test. The control composition comprised a dry, commercial feline food (Feline Mature 26 commercially available from Royal Canin USA, Inc., St. Charles, Mo.). Palatability was determined by comparing the test compositions and the control composition in a standard two-bowl preference test over one day with 25 cats as described in Example 1. Results are shown below in Table 5.

TABLE 5

| Exp. | | Status (vs. | Intake | % Pref. | % Pref. |
|---|---|---|---|---|---|
| No. | Test Composition | Control) | Ratio | Test | Control |
| 1 | Dry, commercial | Win | 0.7578 | 80.0 | 20.0 |
| | feline food with | | | | |
| | 0.2% brewer's yeast | | | | |
| | and 0.2% methionine | | | | |
| | in coating (chicken | | | | |
| | liver flavor) | | | | |
| 2 | Dry, commercial | Win | 0.6182 | 66.7 | 33.3 |
| | feline food with | | | | |
| | 0.2% brewer's yeast | | | | |
| | and 0.2% methionine | | | | |
| | coating | | | | |

In the specification, there have been disclosed typical preferred embodiments of the invention and, although specific terms are employed, they are used in a generic and descriptive sense only and not for purposes of limitation, the scope of the invention being set forth in the following claims. Obviously many modifications and variations of the present invention are possible in light of the above teachings. It is therefore to be understood that within the scope of the appended claims the invention may be practiced otherwise than as specifically described.

What is claimed is:

1. A method for enhancing the palatability of a composition for consumption by an animal comprising adding to the composition a palatability enhancing amount of at least one methionine compound.

2. The method of claim 1 wherein the methionine compound is added to the composition in an amount of at least about 0.01% by weight of the composition.

3. The method of claim 1 wherein the methionine compound is topically applied to the consumption.

4. The method of claim 1 further comprising adding to the composition a palatability enhancing amount of inactive yeast.

5. The method of claim 4 wherein the yeast is added to the composition in an amount of at least about 0.01% by weight of the composition.

6. The method of claim 4 wherein the yeast is topically applied to the consumption.

7. The method of claim 1 wherein the composition is for consumption by a feline or a canine.

8. The method of claim 1 wherein the composition is a food composition.

9. The method of claim 1 wherein the composition is a nutritional diet, a supplement, an animal treat, or an animal toy.

10. A method for increasing the amount of a composition ingested by an animal comprising feeding the animal a composition comprising a palatability enhancing amount of a methionine compound.

11. The method of claim 10 wherein the composition comprises a methionine compound in an amount of at least about 0.01% by weight of the composition.

12. The method of claim 10 wherein the composition further comprises a palatability enhancing amount of inactive yeast.

13. The method of claim 12 wherein the yeast is added to the composition in an amount of at least about 0.01% by weight of the composition.

14. The method of claim 10 wherein the composition is for ingestion by a feline or a canine.

15. The method of claim 10 wherein the composition is a food composition.

16. The method of claim 10 wherein the composition is a nutritional diet, a supplement, an animal treat, or an animal toy.

17. A kit comprising in separate containers in a single package or in separate containers in a virtual package, as appropriate for the kit component, a palatability enhancing amount of at least one methionine compound and at least one of (1) an inactive yeast, (2) one or more ingredients suitable for consumption by an animal, (3) instructions for how to combine the methionine compound and optional yeast and the ingredient(s) to produce a composition for animal consumption having enhanced palatability, and (4) instructions for how to use the composition of the invention.

18. The kit of claim 17 comprising the methionine compound in amounts sufficient to comprise at least about 0.01% by weight of the composition when the methionine compound is admixed with the ingredient.

19. The kit of claim 17 comprising the methionine compound in amounts sufficient to comprise from about 0.01% to about 1.5% by weight of the composition when the methionine compound is admixed with the ingredient.

20. The kit of claim 17 comprising a food composition and the methionine compound in amounts sufficient to comprise from about 0.01% to about 1.5% by weight of the food composition when the methionine compound is admixed with the food composition.

21. A composition suitable for consumption by an animal comprising a palatability enhancing amount of at least one methionine compound.

22. The composition of claim 21 wherein the composition is a food composition.

23. The composition of claim 21 comprising at least about 0.01% of the methionine compound.

24. The composition of claim 21 comprising from about 0.01% to about 1.5% of the methionine compound.

25. The composition of claim 21 further comprising a palatability enhancing amount of inactive yeast.

26. The composition of claim 25 comprising at least about 0.01% of the yeast.

27. The composition of claim 25 comprising from about 0.01% to about 1.5% of the yeast.

28. A dry composition for consumption by an animal comprising a plurality of discrete pieces each having one or more surface zones comprising a methionine compound in an amount effective to enhance palatability of the composition.

29. The composition of claim 28 wherein the amount of methionine compound within the surface zone(s) of said composition comprises at least about 0.01% by weight of the composition.

30. The composition of claim 28 wherein the amount of methionine compound within the surface zone(s) of the composition comprises from about 0.05% to about 0.5% by weight of the composition.

31. The composition of claim 28 further comprising one or more surface zones comprising inactive yeast in an amount effective to enhance palatability of the composition to the animal.

32. The composition of claim 31 wherein the composition comprises one or more surface zone(s) comprising a methionine compound in an amount of from about 0.05% to about 0.5% by weight of the composition and inactive yeast in an amount of from about 0.05% to about 0.5% by weight of the composition.

33. A means for communicating information about or instructions for one or more of (1) using methionine compounds and optional inactive yeasts to enhance the palatability of compositions for animal consumption, (2) using methionine compounds and optional inactive yeasts to increase the amount of a composition ingested by an animal, (3) admixing methionine compounds and optional inactive yeasts with the other components of the present invention, and (4) using the kits of the present invention for enhancing the palatability of compositions for consumption by an animal, and (6) using the kits of the present invention to increase the amount of a composition ingested by an animal, the means comprising a document, digital storage media, optical storage media, audio presentation, or visual display containing the information or instructions.

34. The means of claim 33 selected from the group consisting of a displayed web site, brochure, product label, package insert, advertisement, or visual display.

35. A method for preparing a composition for consumption by an animal comprising topically applying a palatability enhancing amount of a methionine compound to the composition.

36. The method of claim 35 wherein the methionine compound is topically applied to the composition in an amount of from about 0.01% to about 1.5% by weight of the composition.

37. The method of claim 35 wherein the methionine compound is topically applied to the composition in an amount of from about 0.05% to about 0.5% by weight of the composition.

38. The method of claim 35 further comprising topically applying a palatability enhancing amount of inactive yeast to the composition.

39. The method of claim 38 wherein the inactive yeast is topically applied to the composition in an amount of from about 0.01% to about 1.5% by weight of the composition.

40. The method of claim 38 wherein the inactive yeast is topically applied to the composition in an amount of from about 0.02% to about 1.5% by weight of the composition.
